(19) United States
(12) Patent Application Publication
(10) Pub. No.: US 2016/0147259 A1
(43) Pub. Date: May 26, 2016

(54) ELECTRONIC DEVICE

(71) Applicant: KABUSHIKI KAISHA TOSHIBA, Tokyo (JP)

(72) Inventor: Kinji TAKI, Tokyo (JP)

(73) Assignee: KABUSHIKI KAISHA TOSHIBA, Tokyo (JP)

(21) Appl. No.: 14/937,467

(22) Filed: Nov. 10, 2015

Related U.S. Application Data
(60) Provisional application No. 62/082,933, filed on Nov. 21, 2014.

(51) Int. Cl. G06F 1/16; G06F 13/40; H04B 1/3877

(52) U.S. Cl. CPC G06F 1/1632; H04B 1/3877; G06F 13/4081

(57) ABSTRACT

One embodiment provides an electronic device including: a first unit; a first controller in the unit; a second unit; a second controller in this unit; and a transmitting buffer of update information of the second controller which is provided in the first unit, wherein the first controller obtains the update information from an external part and transmits the update information to the second controller from the transmitting buffer and the second controller carries out an updating operation in accordance with the update information.

### CROSS-REFERENCE TO RELATED APPLICATION(S)

This application claims priority from U.S. Provisional Patent Application No. 62/082,933 filed on Nov. 21, 2015, the entire contents of which are incorporated herein by reference.

### TECHNICAL FIELD

An exemplary embodiment of the present invention particularly relates to an electronic device having an extension unit.

### BACKGROUND ART

There is a model in a two in one note PC (Personal Computer) system that has Batteries are respectively mounted on tablet/keyboard docks. In a usual PC (a note type or a Tablet type), a controlling microcomputer (a Flash type) is mounted in a main body side. In a Docking system as an Option, an external I/F or a USB unit (a keyboard or the like) is mounted, however, a control is carried out by the controlling microcomputer (refer it to as an EC, hereinafter) of the main body side.

However, since a controlling microcomputer (refer it to as a 2nd EC, hereinafter) is also mounted on the Docking system side, functions can be more added (a 2nd Battery or an inner KB or the like) to the Docking system side.

A unit which rewrites a firmware (refer it to as an FW, hereinafter) of the EC is present so far. However, since it is a first time that the 2nd EC is mounted on the Docking system, there is no method for rewriting the FW by updating a version or a version-up.

As a related art, since updated data is obtained by a communication in the Docking system side to carry out an updating operation, a problem arises that the updating operation is not carried out when a communication environment does not exist.

### BRIEF DESCRIPTION OF THE DRAWINGS

FIG. 1 is a perspective view showing an external appearance of an electronic device of an exemplary embodiment.

FIG. 2 is a diagram showing a first using style of the electronic device of the exemplary embodiment.

FIG. 3 is a diagram showing a second using style of the electronic device of the exemplary embodiment.

FIG. 4 is a diagram showing a system structure of the electronic device of the exemplary embodiment.

FIG. 5 is an EC/2nd EC rewrite image diagram of the exemplary embodiment.

FIG. 6 is an EC/2nd EC rewrite flowchart for explaining an operation of the exemplary embodiment.

FIG. 7 is an EC/2nd EC rewrite image diagram of the exemplary embodiment (during a docking).

FIG. 8 is an EC/2nd EC rewrite flowchart for explaining an operation of the exemplary embodiment (during a docking).

FIG. 9 is an EC/2nd EC rewrite image diagram 2 of the exemplary embodiment (during a docking).

FIG. 10 is an EC/2nd EC rewrite flowchart 2 for explaining an operation of the exemplary embodiment (during a docking).

FIG. 11 is a diagram which explains an IIC (I²C) interface used in the exemplary embodiment.

FIG. 12 is a diagram showing an example of a pop-up display on an LCD 11A according to the one exemplary embodiment.

### MODE FOR CARRYING OUT THE INVENTION

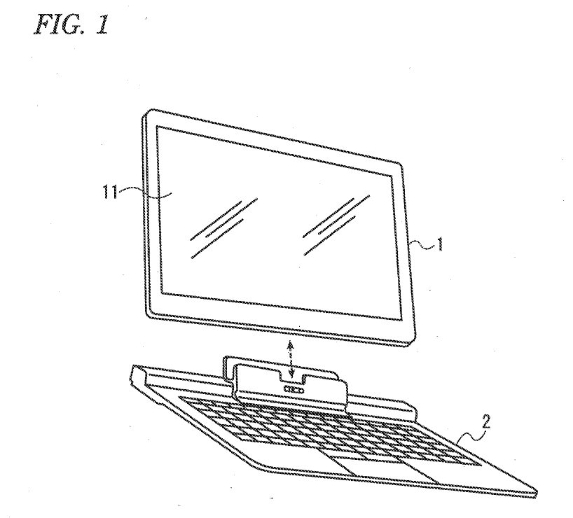

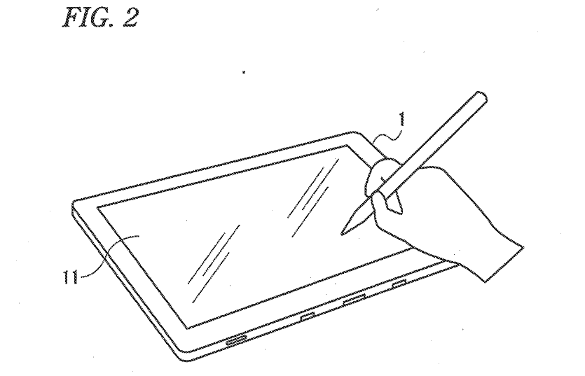

Now, referring to FIG. 1 to FIG. 12, exemplary embodiments will be described below.

FIG. 1 is a perspective view showing an external appearance of an electronic device of one exemplary embodiment. The electronic device is, for instance, a portable electronic device in which a handwritten input can be achieved by a pen or a finger. In a below-described case, the electronic device is supposed to be realized as a tablet computer 1.

As shown in FIG. 1, the tablet computer 1 includes a touch screen display 11. The touch screen display 11 is attached so as to be superposed on an upper surface of the tablet computer 1. In the touch screen display 11, are built a flat panel display and a sensor formed so as to detect a contact position of the pen or the finger on a screen of the flat panel display. The flat panel display is, for instance, a liquid crystal display device (an LCD). The sensor is, for instance, an electrostatic capacity type touch panel or an electromagnetic induction type digitizer. In this case, both two kinds of the sensors of the digitizer and the touch panel are supposed to be built in the touch screen display 11.

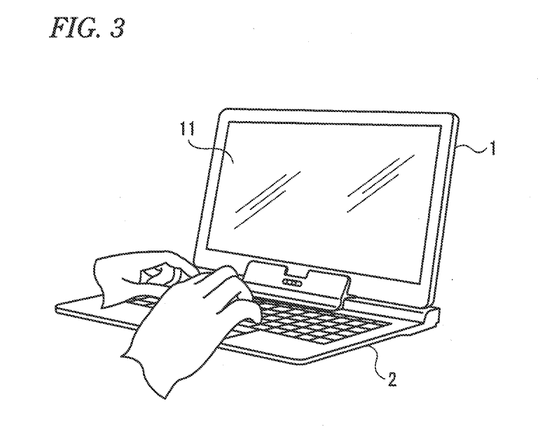

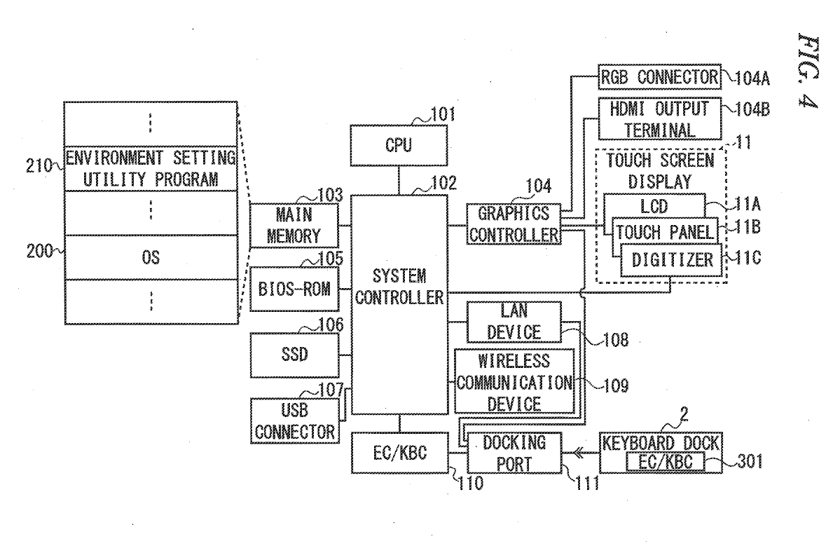

Further, as shown in FIG. 1, the tablet computer 1 is formed so that an extension unit 2 on which a keyboard is mounted may be connected thereto as required. In a below-described explanation, the extension unit 2 is referred to as a keyboard dock 2. Namely, the present tablet computer 1 can be used in two kinds of styles including a state of a single main body (the keyboard dock is not connected) as shown in FIG. 2 and a state that the keyboard dock 2 is connected thereto as shown in FIG. 3. The state shown in FIG. 2 is referred to as a tablet mode. On the other hand, the state shown in FIG. 3 is referred to a clam shell mode.

FIG. 4 is a diagram showing a system structure of the present tablet computer 1.

The tablet computer 1 includes, as shown in FIG. 4, a CPU 101, a system controller 102, a main memory 103, a graphics controller 104, an RGB connector 104A, an HDMI (a registered trademark) (High-definition multimedia interface) output terminal 104B, a BIOS-ROM 105, an SSD (Solid state drive) 106, a USB connector 107, an LAN device 108, a wireless communication device 109, an EC/KBC (Embedded controller/Keyboard controller) 110 and a docking port 111.

The CPU 101 is a processor which controls operations of various kinds of modules in the tablet computer 1. The CPU 101 loads various kinds of programs in the main memory 103 from the SSD 106 to execute the programs. The programs executed by the CPU 101 include an operating system (OS) 200 or a below-described environment setting utility program 210 operating under the control of the OS 200.

Further, the CPU 101 also executes a basic input and output system (BIOS [designate it as a BIOS 250, hereinafter]) stored in the BIODS-ROM 105. The BIOS 250 is a program which controls hardware.

The system controller 102 is a device which connects a local bus of the CPU 101 to various kinds of components. In the system controller 102, a memory controller which controls an access of the main memory 103 and a serial ATA controller which controls an access of the SSD 106 are built. Further, the system controller 102 has a function for carrying out a communication with the graphics controller 104 and the EC/KBC 110 through a serial bus.

The graphics controller 104 is a display controller which controls an LCD 11A used as a display monitor of the tablet computer 1. The graphics controller 104 generates display signals (LVDS signals) to be supplied to the LCD 11A from display data outputted by the various kinds of programs. The graphics controller 104 can generate an analog RGB signal and an HDMI video signal from the display data. The analog RGB signal is supplied to an external display through the RGB connector 104A and the HDMI video signal is supplied to the external display through the HDMI output terminal 104B. The HDMI output terminal 104B is a terminal which can transmit the HDMI video signal (the non-compressed digital video signal) and a digital audio signal by one cable. The graphics controller 104 can also transmit the analog RGB signal and the HDMI video signal to the keyboard dock 2 through the docking port 111. The docking port 111 is a port for electrically connecting the tablet computer 1 to the keyboard dock 2.

The LCD 11A displays a screen image in accordance with the display signal supplied from the graphics controller 104. In an upper layer of the LCD 11A, a touch panel 11B is arranged as a first sensor which detects the contact position of the finger on the screen. Further, in a lower layer of the LCD 11A, a digitizer 11C is arranged as a second sensor which detects the contact position of the pen on the screen. The touch panel 11B is the electrostatic capacity type pointing device. The contact position on the screen with which the finger is allowed to come into contact and movement of the contact position are detected by the touch panel 11B. On the other hand, the digitizer 11C is the electromagnetic induction type pointing device. The contact position on the screen with which the pen is allowed to come into contact and movement of the contact position are detected by the digitizer 11C.

The USB connector 107 is a connector which connects a USB device, for instance, a USB memory. The LAN device 108 is a device which carries out a wired communication based on, for instance, an IEEE 802.3 standard. A connection of the tablet computer 1 to an LAN is carried out by connecting a LAN cable to a LAN connector provided in the keyboard dock 2 side connected to the docking port 111. The wireless communication device 109 is a device which carries out a wireless communication based on, for instance, an IEEE 802.11g standard.

The EC/KBC 110 is a controller which controls a power source of the tablet computer 1 and has functions that control the power source of the tablet computer 1 to be turned on and turned off, monitor a power inputted from an incorporated battery and an AC adapter, control a power source of an incorporated device (the LAN or the wireless communication device) and control an LED to display a state of an electric power or display a turning on/off state of a power source.

Further, an EC/KBC 301 is a controller which controls a power source of the keyboard dock 2 and has functions that control the power source of the keyboard dock 2 to be turned on and turned off, monitor a power inputted from an incorporated battery and an AC adapter, control a power source of an incorporated device (a USB power source) and control an LED to display a state of an electric power or a keyboard back light or display a turning on/off state of a power source. Further, the EC/KBC 301 incorporates therein a keyboard controller which controls the keyboard or a touch pad mounted on the keyboard dock 2.

Now, the power of the tablet computer 1 is supposed to be turned on under a state that the keyboard dock 2 is connected to the docking port 111. When the power of the tablet computer 1 is turned on, the BIOS 250 carries out a POST (Power on self test). The BIOS 250 diagnoses various kinds of components of the tablet computer 1 by the POST to initialize settings of the various kinds of components. In the POST, the BIOS 250 recognizes that the keyboard dock 2 is connected to the tablet computer and obtains a Dock-ID from the keyboard dock 2. Then, the tablet computer 1 activates the OS 200. When the OS 200 is activated, in the present tablet computer 1, the environment setting utility program 210 is activated under the control of the OS 200.

When the environment setting utility program 210 is activated, the environment setting utility program 210 initially obtains the Dock-ID of the keyboard dock 2 from the BIOS 250.

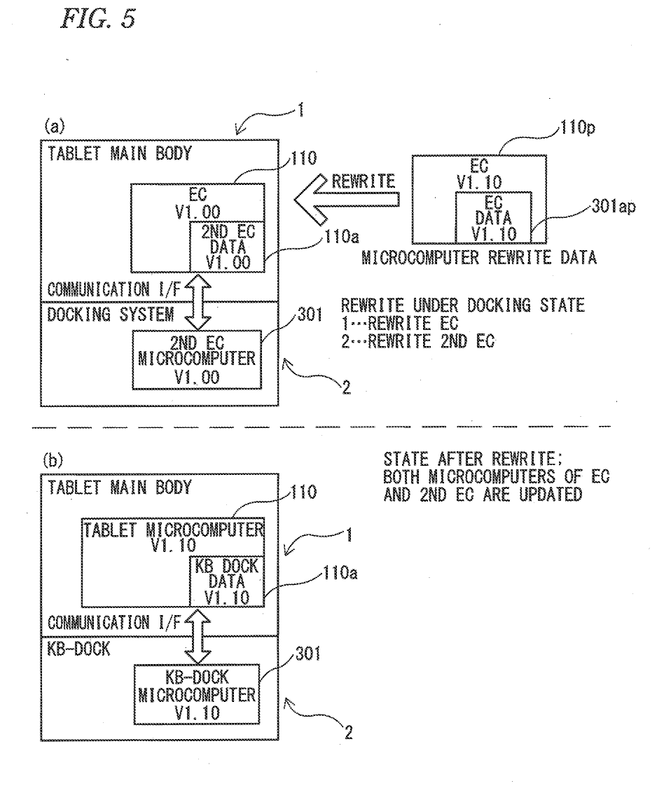

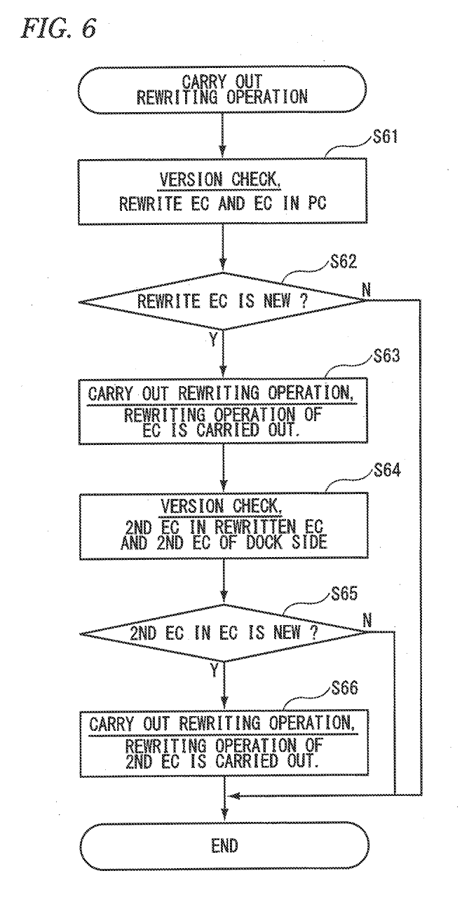

FIG. 5 is an EC(EC/KBC 110)/2nd EC(EC/KBC 310)rewrite image diagram showing main parts of the exemplary embodiment. The environment setting utility program 210 (refer it to as an application, hereinafter) cooperates with the EC/2nd EC to carry out below-described rewriting operations shown in FIG. 6 and drawings after FIG. 6 (allow the below-described rewriting operations to be carried out). FIG. 5 and FIG. 6 show a case that the rewriting operation of an EC of the latest version is carried out under a Docked (a connected) state by a user. Section (a) of FIG. 5 shows a state before the rewriting operation is carried out and versions of (firmware) of both the EC/2nd EC are v1.00. Section (b) of FIG. 5 shows a state after the rewriting operation is carried out and versions of both the EC/2nd EC are v1.10. The EC and the 2nd EC are formed so as to communicate with each other by a below-described IIC interface.

FIG. 6 is an EC/2nd EC rewrite flowchart which shows main operations of the exemplary embodiment.

When update information (microcomputer rewrite data: 110p, 301ap) of the EC/2nd EC is received from an Internet environment or other external part, the flowchart is started. Initially, a version is checked. When the version of a rewrite side is new, the rewriting operation is carried out. Then, the version of the 2nd EC of the Dock side is recognized. When the version of the 2nd EC included in the rewritten EC is new, the rewriting operation of the 2nd EC is carried out.

Step S61: Initially, the version is checked by the EC (Recognize the update information). Rewrite EC 110p is compared with the EC (110) in the PC (the tablet computer 1).
Step S62: As a result of a comparison in the step S61, when the EC 110P side is new, the flowchart advances to next step S63. When the rewrite EC 110p side is not new, the flow is finished.
Step S63: The EC carries out the rewriting operation of its own.
Step S64: The EC checks the version (Recognize the update information). A 2nd EC buffer 110a in the rewritten EC is compared with the 2nd EC (301) of the Dock (the keyboard dock 2) side.
Step S65: As a result of a comparison in the step S64, when the 2nd EC buffer 220a side is new, the flowchart advances to next step S66. Otherwise, the flow is finished.
Step S66: The EC transmits contents of the 2nd EC buffer 110a to the 2nd EC. The 2nd EC carries out the rewriting operation of its own in accordance with the contents. Then, the flow is finished.

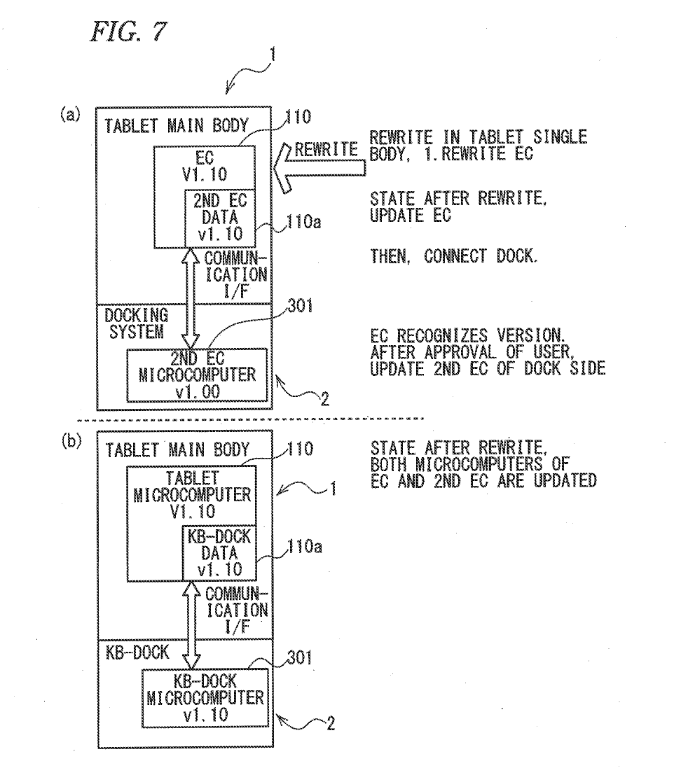

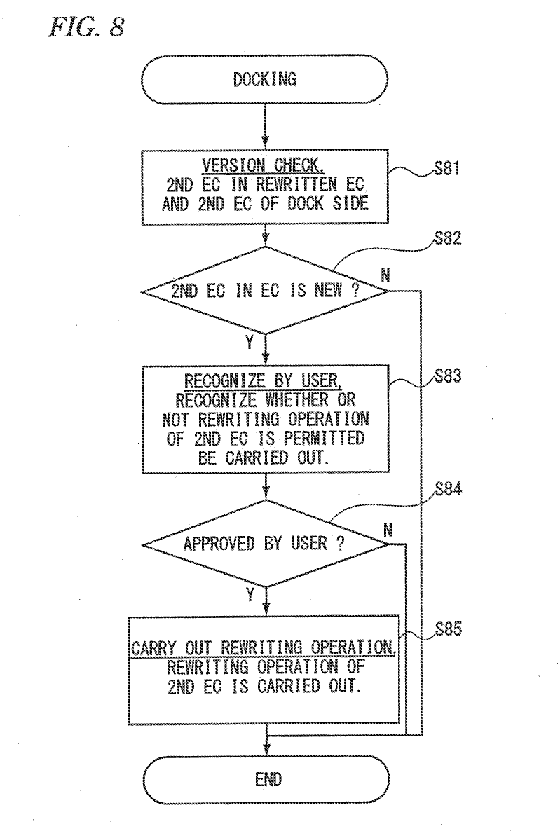

FIG. 7 is an EC/2nd EC rewrite image diagram showing main parts of a second exemplary embodiment. FIG. 7 and FIG. 8 show a case that a rewriting operation of an EC of the latest version is to be carried out during a Docking operation (a connection) by a user. Section (a) of FIG. 7 shows a case that after the rewriting operation is carried out only in a tablet side, the tablet side is Docked to a keyboard dock, or a state that the tablet side is Docked to the keyboard dock having a 2nd EC of an old version. Thus, the version of the EC is v1.10 and the version of the 2nd EC is yet v1.00. Section (b) of FIG. 7 shows a state after the rewriting operation is carried out and versions of both the EC/2nd EC are v1.10.

FIG. 8 is an EC/2nd EC rewrite flowchart which shows main operations of the second exemplary embodiment. Since update information of the EC/2nd EC is already received from an external part, however, the tablet side is undocked to the keyboard dock, when a Docking operation is carried out by the user under a state that the rewriting operation is carried out only in the EC side (a version check is carried out), the flowchart is started. Initially, the version of the 2nd EC of the Dock side is recognized. When the version of the 2nd EC included in the rewritten EC is new, if the tablet side is Docked to the Dock side by the user when a system is in a state off, things which are required to be rewritten are recorded in a memory in the EC not shown in the drawing and reported after an activation. When the table side is Docked to the Dock side by the user when the system is in a state of on, the things required to be rewritten are reported after the version is recognized. When an approval is obtained from the user, the rewriting operation is carried out. When the approval is not obtained from the user, the rewriting operation is not carried out, and the things required to be rewritten are reported again during a next activation.

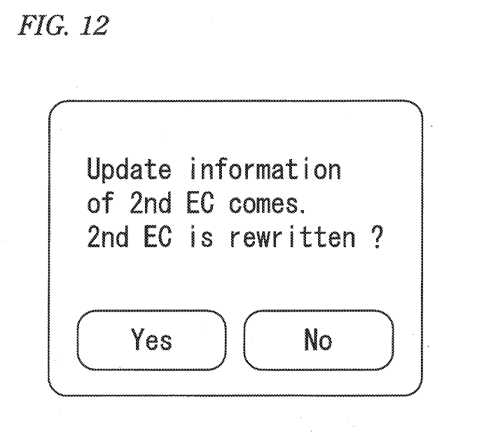

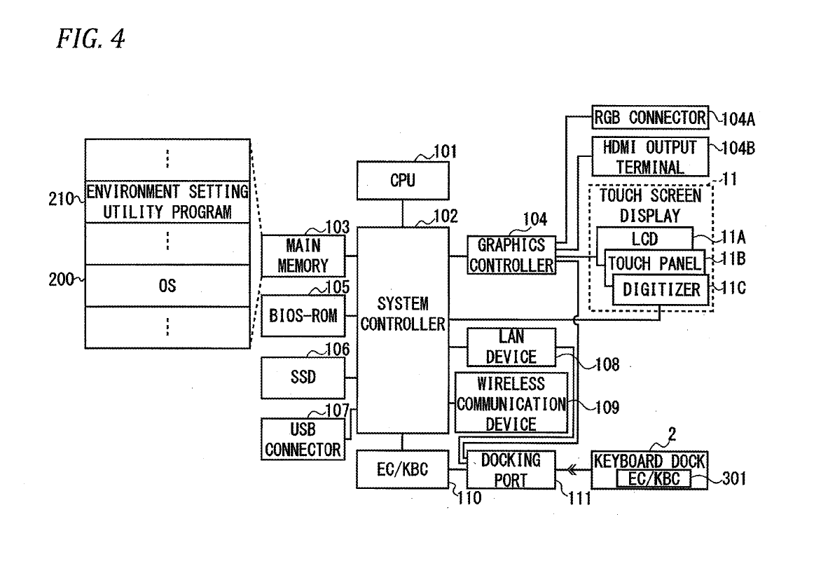

Step S81: The EC checks the version (Recognize the update information). A 2nd EC buffer 110a in the EC is compared with the 2nd EC (301) of the Dock (the keyboard dock 2) side.
Step S82: As a result of a comparison in the step S81, when the rewrite EC 110p side is new, the flowchart advances to next step S83. Otherwise, the flow is finished.
Step S83: Recognition by the user is carried out by an application. It is recognized whether or not the rewriting operation of the 2nd EC is carried out (see FIG. 12).
Step S84: When the approval of the user is obtained, the EC advances to next step S85 by a command of the application. Otherwise, the flow is finished.
Step S85: The 2nd EC carries out the rewriting operation of its own in accordance with the contents of the 2nd EC buffer 110a. Then, the flow is finished.

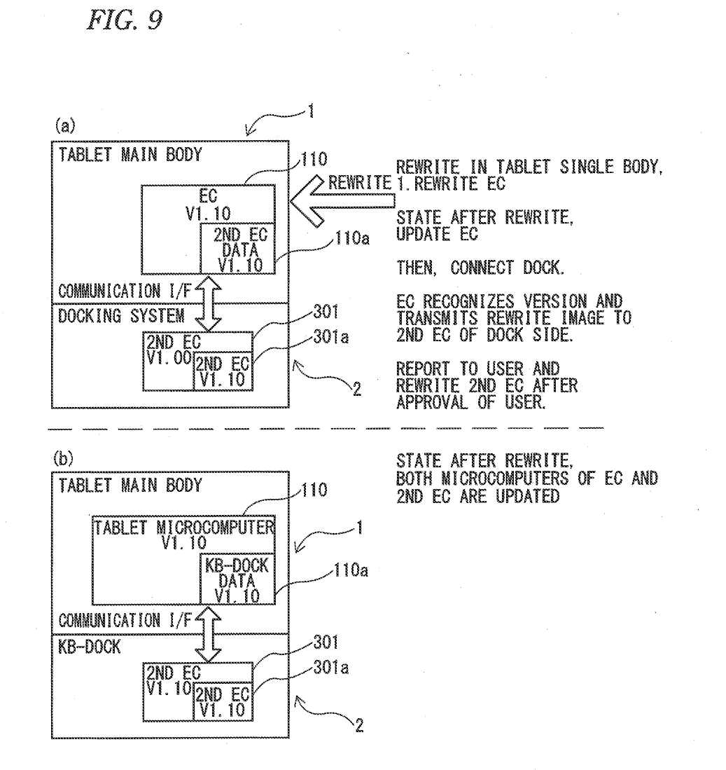

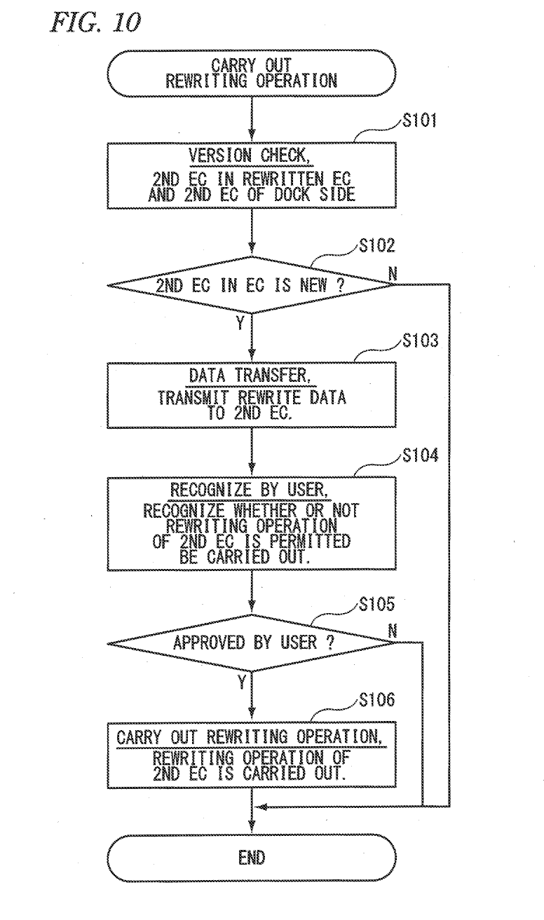

FIG. 9 is an EC/2nd EC rewrite image diagram showing main parts of a third exemplary embodiment. FIG. 9 and FIG. 10 show a case that a rewriting operation of an EC of the latest version is to be carried out during a Docking operation (a connection) by a user. Section (a) of FIG. 9 shows a case that after the rewriting operation is carried out only in a tablet side, the tablet side is Docked to a keyboard dock, or a state that the tablet side is Docked to the keyboard dock having a 2nd EC of an old version and the latest version is already completely transmitted to the 2nd EC side. Thus, the version of the EC is v1.10 and the version of the 2nd EC is yet v1.00 (However, in this case, v1.10 is received in a memory in the 2nd EC). Section (b) of FIG. 9 shows a state after the rewriting operation is carried out and the versions of both the EC/2nd EC are v1.10.

FIG. 10 is an EC/2nd EC rewrite flowchart which shows main operations of the exemplary embodiment. Since the tablet side is undocked to the keyboard dock, when a Docking operation is carried out by the user under a state that the rewriting operation is carried out only in the EC side (a version check is carried out), the flowchart is started. Initially, the version of the 2nd EC of the Dock side is recognized. When the version of the 2nd EC included in the rewritten EC is new, the EC previously transmits rewrite data to the 2nd EC to store the rewrite data in the 2nd EC. When the tablet side is Docked to the Dock side by the user when a system is in a state of off, things which are required to be rewritten are recorded in a memory in the EC not shown in the drawing and reported after an activation. When the tablet side is Docked to the Dock side by the user when the system is in a state of on, the things required to be rewritten are reported after the version is recognized. When an approval is obtained from the user, the rewriting operation is carried out. When the approval is not obtained from the user, the rewriting operation is not carried out, and the things required to be rewritten are reported again during a next activation.

Step S101: The EC checks the version (Recognize the update information). A 2nd EC buffer 110a in the rewritten EC is compared with the 2nd EC (301) of the Dock (the keyboard dock 2) side.
Step S102: As a result of a comparison in the step S101, when the rewrite EC 110p side is new, the flowchart advances to next step S103. Otherwise, the flow is finished.
Step S103: Data is transferred to a 2nd EC (receiving) buffer 301a from the 2nd EC buffer 110a. The rewrite data is transmitted to the 2nd EC.
Step S104: Recognition by the user is carried out by an application. It is recognized whether or not the rewriting operation of the 2nd EC is carried out (see FIG. 12).
Step S105: When an approval of the user is obtained, the EC advances to next step S106 by a command of the application. Otherwise, the flow is finished.
Step S106: The 2nd EC carries out the rewriting operation of its own in accordance with the contents of the 2nd EC (receiving) buffer 301a. Then, the flow is finished.

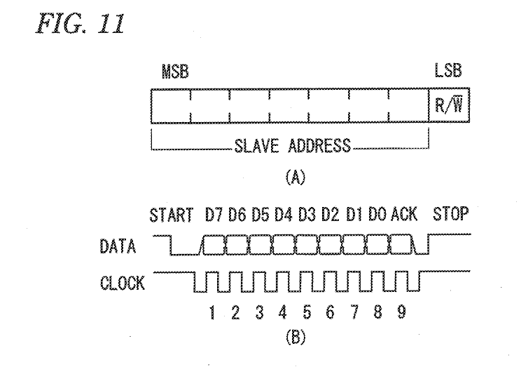

FIG. 11 is a diagram which explains the above-described IIC interface. A bus (IIC-BUS) of the IIC interface includes two communication lines including clocks outputted to be pulled up from a master device and data which carries out a bidirectional communication of the master device and a slave device.

FIG. 11(a) shows an example of a structure of a device address. The device address is formed with high-order 7 bits. Further, when a low-order 1 bit is 0, this designates writing, and when the low-order 1 bit is 1, this designates a reading.

FIG. 11(b) is a schematic diagram of timing of the two lines. As shown in an upper side, when a level value of a signal of the data line is LOW, a Start state is obtained, so that the data is sent hereafter from the high-order bits. When a level value of a signal of the data lien is HIGH, a Stop state is obtained. The timing of a corresponding clock line is shown in a lower side. FIG. 11(b) shows an example of a one bite transfer. When the data and ACK are repeated a plurality of times until the Stop state, a first byte is a slave address, however, remaining bytes can be set to contents of a communication.

FIG. 12 is a diagram showing an example of a pop-up display on the LCD 11A as an approving unit of the application of the exemplary embodiment. A message of “The update information of the 2nd EC comes. Is the rewriting operation of the 2nd EC carried out?” is displayed. When the user selects a button of “Yes”, the rewriting operation is carried out. In the selection of a button of “No”, a present 2nd EC is maintained.

In the above-described exemplary embodiments, since the data of the 2nd EC is included in the EC, even when a plurality of Docks are provided, the 2nd EC of the Dock side can be rewritten to the latest version irrespective of the communication environment. Specifically, a microcomputer rewriting method has such contrivances as described below.

(1) As a unit which rewrites a 2nd EC, data of the 2nd EC is included in an EC. As one unit of rewriting, after the EC of a main body side is rewritten, a version of the original 2nd EC and a version of the included 2nd EC are recognized. When the version of the included 2nd EC is newer, the 2nd EC is rewritten.
(2) After only the EC of the main body side is rewritten under an Undocked state, the version of the 2nd EC is obtained when the main body side is next Docked to a dock side. The obtained version is compared with the version of the 2nd EC included in the EC. When the version of the included 2nd EC is newer, a user is informed that the 2nd EC needs to be updated. After an approval of rewriting is obtained, the 2nd EC is rewritten. When the user does not approve of rewriting the 2nd EC, the 2nd EC is not rewritten.
(3) When the version of the included 2nd EC is newer after the main body side is docked to the dock side like the above-described (2), only rewrite data is transferred to the 2nd EC (in a space area of a ROM in the 2nd EC). After a system is activated, the user is informed that the 2nd EC needs to be updated. After an approval of rewriting is obtained, the 2nd EC is rewritten. When the user does not approve of rewriting the 2nd EC, the 2nd EC is not rewritten.

The present invention is not limited to the above-described exemplary embodiments and may be additionally modified in various ways and embodied within a scope that does not deviate from the gist thereof For instance, for a communication, the IIC is described as a representative example, however, another communication method may be adopted.

Further, when the plurality of component elements disclosed in the above-described exemplary embodiments are suitably combined together, various inventions may be devised. For instance, some component elements may be deleted from all the component elements disclosed in the exemplary embodiments. Further, the component elements of the different exemplary embodiments may be suitably combined together.

What is claimed is:

1. An electronic device comprising:
a first body;
a first controller in the first body;
a second body attachable to the first body;
a second controller in the second body; and
a transmitting buffer memory provided in the first body and configured to store update information, the update information being used to update setting information in the second controller, wherein the first controller obtains the update information from an external part and transmits the update information to the second controller from the transmitting buffer memory and the second controller carries out an updating operation in accordance with the update information.

2. An electronic device according to claim 1, further comprising:
an approving unit provided in the first unit or the second unit, wherein the approving unit allows the second controller to be updated in accordance with the update information by an instruction of an approval from an external part.

3. An electronic device according to claim 1, further comprising:
a receiving buffer of the update information provided in the second unit, wherein the second unit receives the update information in the receiving buffer when the second unit is connected to the first unit.

4. An electronic device according to claim 3, further comprising:
an approving unit provided in the first unit or the second unit, wherein the approving unit allows the second controller to be updated in accordance with the update information by an instruction of an approval from an external part.
